(19) United States
(12) Patent Application Publication
(10) Pub. No.: US 2024/0040675 A1
(43) Pub. Date: Feb. 1, 2024

(54) HEATING DEVICE AND HEATING METHOD THEREOF

(71) Applicant: Feng-Wen LIU, Taipei City (TW)

(72) Inventor: Feng-Wen LIU, Taipei City (TW)

(21) Appl. No.: 18/352,266

(22) Filed: Jul. 14, 2023

(30) Foreign Application Priority Data
Jul. 14, 2022 (TW) 111126521

(51) Int. Cl. H05B 6/10; F24H 1/14

(52) U.S. Cl. CPC H05B 6/108; F24H 1/142

(57) ABSTRACT

A heating device includes a main body, a first member, a second member, a third member, an induction coil, a support member, and a magnetic induction element. The main body has an accommodating space and is configured to accommodate a fluid. The main body includes a first end part and a second end part opposite to the first end part. The first member is connected to the first end part of the main body. The second member is connected to the second end part of the main body. The third member is connected to the second member. The induction coil surrounds an outside of the main body. The support member includes base and a plurality of extension parts connected to the base. The magnetic induction element is disposed in the accommodating space.

### CROSS-REFERENCE TO RELATED APPLICATION

This application claims priority to Taiwan Application Serial Number 111126521, filed Jul. 14, 2022, which is herein incorporated by reference.

### BACKGROUND

### Field of Invention

The present disclosure relates to a heating device and a method for heating a fluid. More particularly, the present disclosure relates to a device for heating fluid using electromagnetic induction heating and a heating method thereof.

### Description of Related Art

For heating a fluid, an outside surface of the container can be heated, and then the fluid inside the container is heated by conduction, or the fluid inside the container is directly heated by microwave. However, the above approaches have problems of thermal energy dissipation and bumping.

Electromagnetic induction heating is a heating method which introduces alternating currents into an induction coil. According to Faraday's law of induction, the induction coil generates a change in magnetic flux and induces the magnetic induction element, and then an eddy current is generated on the magnetic induction element. An eddy current loss and the hysteresis phenomenon caused by the eddy current cause hysteresis loss, and the generation of resistance heat may instantly generate thermal energy on a surface of the magnetic induction element.

In view of the above, improving the thermal energy conversion of the magnetic induction element and the thermal energy transfer in the fluid is an important factor affecting the heating of the fluid. Therefore, it is still necessary to rely on continuous improvements in research and development technology to overcome the aforementioned problems.

### SUMMARY

The present disclosure provides a heating device. The heating device includes a main body, a first member, a second member, a third member, an induction coil, a support member, and a first magnetic induction element. The main body has an accommodating space, wherein the main body is configured to accommodate a fluid, the main body includes a first end part and a second end part opposite to the first end part. The first member is connected to the first end part of the main body. The second member is connected to the second end part of the main body. The third member is connected to the second member. An outside of the main body is surrounded by the induction coil. The support member includes a first base and a plurality of first extension parts connected to the first base. The first base is connected to the third member, and the first extension parts respectively extended to the accommodating space. The first magnetic induction element is disposed in the accommodating space.

In some embodiments, the heating device further includes a second magnetic induction element, the support member further includes a second base and a plurality of second extension parts connected to the second base, the main body is disposed inside the second magnetic induction element, the second base is connected to the third member, and the second extension parts are respectively connected to the second magnetic induction element.

In some embodiments, the first magnetic induction element is made of a magnetic induction material including iron-based materials, nickel-based materials, cobalt-based materials, titanium-based materials, ferrite-based materials, or graphite.

In some embodiments, first magnetic induction element further includes a cladding layer, and the cladding layer is made of glass or Teflon material.

In some embodiments, the first magnetic induction element is presented in a form of solid, hollow, porous, sheet stacked, or powder.

In some embodiments, the main body is made of a non-magnetic induction material including polymer, glass, or ceramic, or a magnetic induction material including iron-based materials, nickel-based materials, cobalt-based materials, titanium-based materials, ferrite-based materials, or graphite.

The present disclosure provides a heating device. The heating device includes a main body, a first member, a second member, a third member, an induction coil, a support member, and a magnetic induction element. The main body has an accommodating space, wherein the main body is configured to accommodate a fluid, the main body includes a first end part and a second end part opposite to the first end part. The first member is connected to the first end part of the main body. The second member is connected to the second end part of the main body. The third member is connected to the second member. An outside of the main body is surrounded by the induction coil. The support member includes a first base, a plurality of first extension parts connected to the first base, a second base, and a plurality of second extension parts connected to the second base. The first base and the second base are connected the third member, the first extension parts are respectively extended to the accommodating space. The magnetic induction element is disposed on the outside of the main body, wherein the second extension parts are respectively connected to the magnetic induction element.

In some embodiments, the magnetic induction element is made of a magnetic induction material including iron-based materials, nickel-based materials, cobalt-based materials, titanium-based materials, ferrite-based materials, or graphite.

In some embodiments, the main body is made of a non-magnetic induction material including polymer, glass, or ceramic, or a magnetic induction material including iron-based materials, nickel-based materials, cobalt-based materials, titanium-based materials, ferrite-based materials, or graphite.

In some embodiments, the magnetic induction element and the support member are physically connected by tight matching, clamping, locking, riveting, or tenoning, or chemically connected by welding or gluing.

The present disclosure provides a method for heating a fluid. The method includes the following operations. The fluid is heated with a heating device, wherein the heating device includes a main body having an accommodating space, and an outside of the main body is surrounded by the induction coil. The heating device further includes a first member, a second member, a third member, a support member, and a first magnetic induction element. The first member is connected to a first end part of the main body. The second member is connected to a second end part of the main body, wherein the second end part is opposite to first end part. The third member is connected to the second member. The support member includes a first base and a plurality of first extension parts connected to the first base. The first base is connected to the third member, and the first extension parts are extended to the accommodating space. The first magnetic induction element is disposed in the accommodating space. The operation of heating the fluid includes providing the fluid into the accommodating space from a top of the main body; generating a magnetic field by the induction coil using an alternating current power source, thereby defining an electromagnetic induction heating area; and heating the fluid with the electromagnetic induction heating area, wherein the first magnetic induction element is electromagnetically heated by the magnetic field. After the operation of heating the fluid, the fluid forms a liquid and a gas, wherein the gas is discharged from the top of the main body, and the liquid is discharged from a bottom of the main body.

In some embodiments, the method for heating the fluid further includes closing a valve located below the heating device, before providing the fluid into the accommodating space from the top of the main body.

In some embodiments, the method for heating the fluid further includes detecting a liquid level of the fluid with a liquid level gauge inside the main body and determining whether the heating of the fluid is completed with the liquid level during heating the fluid.

In some embodiments, the method for heating the fluid further includes opening a valve located below the heating device, after heating the fluid.

In some embodiments, the support member further includes a second base and a plurality of second extension parts connected to the second base, and the second base is connected to the third member. The heating device further includes a second magnetic induction element, and the second magnetic induction element is disposed on an outside of the accommodating space, and the second extension parts are respectively extended to and connected to the second magnetic induction element. During the operation of heating the fluid with the electromagnetic induction heating area, the second magnetic induction element is electromagnetically heated by the magnetic field.

The above description will be described in detail below in terms of implementation, and a further explanation will be provided for the technical solution of the disclosure.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a block diagram of a heating system in accordance with some embodiments of the present disclosure.

FIG. 2 is a side view of a fluid handling device in accordance with some embodiments of the present disclosure.

FIG. 3, FIG. 4A, FIG. 5A, FIG. 6A, and FIG. 7A are side views of heating devices in accordance with some embodiments of the present disclosure.

FIG. 4B is a three-dimensional diagram of a support member of a heating device in FIG. 4A.

FIG. 4C is a three-dimensional diagram of a support member and a magnetic induction element of a heating device in FIG. 4A.

FIG. 5B is a three-dimensional diagram of a support member of a heating device in FIG. 5A.

FIG. 5C is a stereogram of a support member and a magnetic induction element of a heating device in FIG. 5A.

FIG. 6B is a stereogram of a support member of a heating device in FIG. 6A.

FIG. 6C is a stereogram of a support member and a magnetic induction element of a heating device in FIG. 6A.

FIG. 7B is a stereogram of a support member and a magnetic induction element of a heating device in FIG. 7A.

FIG. 8 is a flowchart of a method for heating a fluid in accordance with

some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals or letters in the various examples. This repetition is for the purpose of simplicity and clarity and does not in itself dictate a relationship between the various embodiments and configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. That is, when the orientation of the device is different from the drawings (rotated 90 degrees or at other orientations), the spatially relative terms used in the present disclosure can also be interpreted accordingly.

It will be understood that, although the terms “first,” “second,” etc. may be used herein to describe various elements, these elements should not be limited by these terms. These terms are only used to distinguish one element from another. For example, a “first element” may be termed a “second element,” and, similarly, a “second element” may be termed a “first element,” without departing from the scope of the embodiments. As used herein, the term “and/or” includes any and all combinations of one or more of the associated listed items.

The heat pump technology, for example, may be used to concentrate or distill a fluid, but the heat pump has a maximum temperature limit (for example, 60˜90° C.) due to its working principle, and a heating efficiency of the heat pump is slow. In addition, the heat pump technology is not suitable for corrosive or extremely pure fluids. In comparison with the heat pump technology, an electromagnetic induction heating technology has the advantage of a fast heating rate. In comparison with traditional methods of heating the outside surface of the container and microwave heating, the electromagnetic induction heating technology may reduce thermal energy dissipation and avoid problems such as bumping.

The present disclosure provides a heating device that utilizes a heating method of an electromagnetic induction coil to heat a liquid in a main body. The heating device of the present disclosure may be used to reduce problems such as thermal energy dissipation or bumping, and improve a heating efficiency of a heating fluid, thereby effectively controlling a heating system. A magnetic induction element in the disclosed heating device is a stable material in acidic and alkaline fluids, so it can be applied to a fluid with a high chemical sensitivity. Therefore, a service life of the heating device may be increased and a fluid purity may be maintained.

It should be noted that the “fluid” used herein may be a liquid or a gas, and the fluid to be heated may be a chemically reactive liquid, a viscous fluid, or acid or base liquids in an industrial process. However, the heating device and the method for heating fluid disclosed in present disclosure may also be used to heat food-grade fluids such as milk and drinks, general fluids, or high-purity fluids, without departing from the scope of the embodiments of this application. A temperature of the heating fluid may be adjusted depending on the properties of the fluid. The same or similar components are given the same reference numerals. Unless otherwise specified, the same reference numerals have the same features and the related descriptions are omitted.

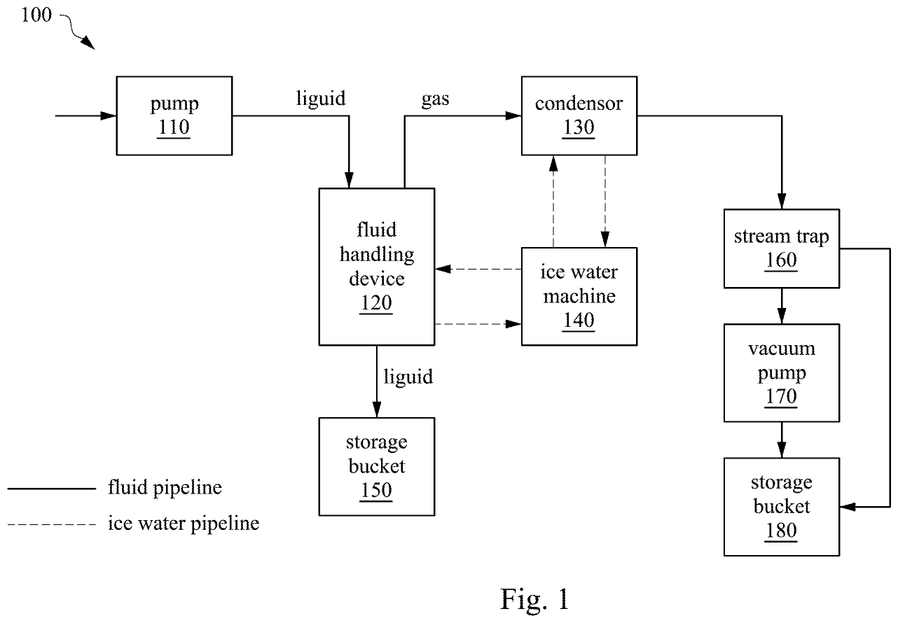

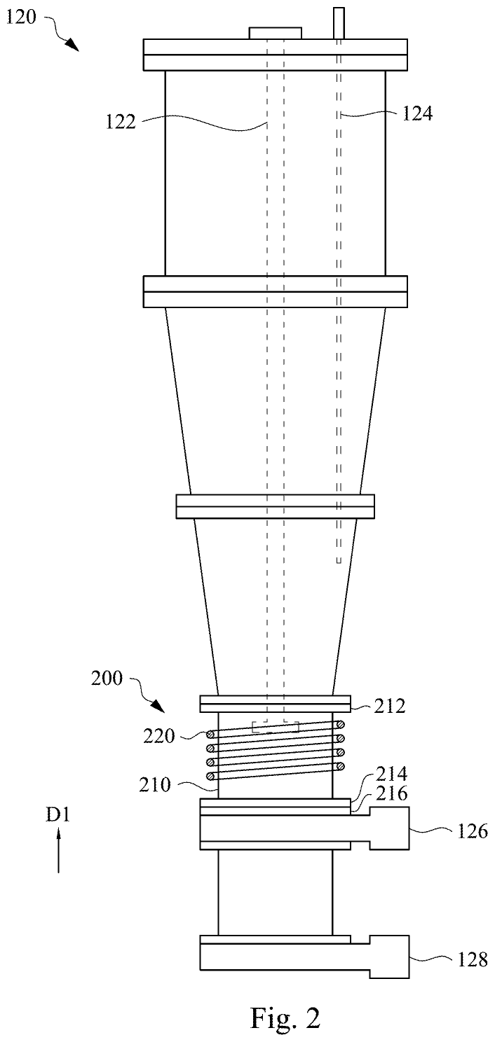

FIG. 1 is a block diagram of a heating system 100 in accordance with some embodiments of the present disclosure. The heating system 100 includes a pump 110, a fluid handling device 120, a condenser 130, an ice water machine 140, a storage bucket 150, a steam trap 160, a vacuum pump 170, and a storage bucket 180. As shown in FIG. 1, a liquid to be treated is transported by the pump 110 in the heating system 100. The fluid handling device 120 includes a heating device 200 (referring to FIG. 2). The condenser 130 is used to condense and recover gases from the fluid handling device 120. The ice water machine 140 is connected to the condenser 130, and the ice water machine 140 may also be connected to an induction coil 220 (referring to FIG. 2) in the fluid handling device 120 to reduce a temperature of the induction coil 220. After being treated by the condenser 130, the fluid to be recovered passes through the steam trap 160 and/or the vacuum pump 170 and the water storage tank 180 to complete the recovery. The liquid treated by the fluid handling device 120 may be transported to the storage bucket 150 for collection.

FIG. 2 is a side view of the fluid handling device 120 in accordance with some embodiments of the present disclosure. The fluid handling device 120 includes a plurality of main bodies for loading liquids and/or gases, and the heating device 200 is located at the rear of the fluid treatment device 120. The fluid handling device 120 is disposed along its axial direction D1. In some examples, the fluid handling device 120 includes a stirrer 122 and a detector 124, and the detector 124 may be, for example, a thermometer and/or a liquid level gauge. Specifically, the stirrer 122 is disposed in or above the heating device 200. The detector 124 is disposed above the heating device 200. The stirrer 122 may cause the fluid in the fluid handling device 120 to generate convection and evenly heat the fluid to improve an effect of the heat exchange. The stirrer 122 may be, for example, a stirring blade, but is not limited thereto.

The heating device 200 in FIG. 2 includes a main body 210 and the induction coil 220, and the main body 210 is disposed between a member 212 and a member 214. The main body 210 has an accommodating space for accommodating the liquid and/or the gas. In some embodiments, the member 212 and/or the member 214 may be an annular member or a polygonal (such as quadrilateral, hexagonal or octagonal, etc.) member. There are one or more draining devices 126 and 128 below the heating device 200. It should be understood that because the stirrer 122 and the detector 124 are located inside the main body 210, they are shown as dotted lines. In addition, the induction coil 220 is disposed outside and around the heating device 200 and does not contact the heating device 200. The induction coil 220 may be, for example, a hollow copper coil with a cooling water pipeline inside.

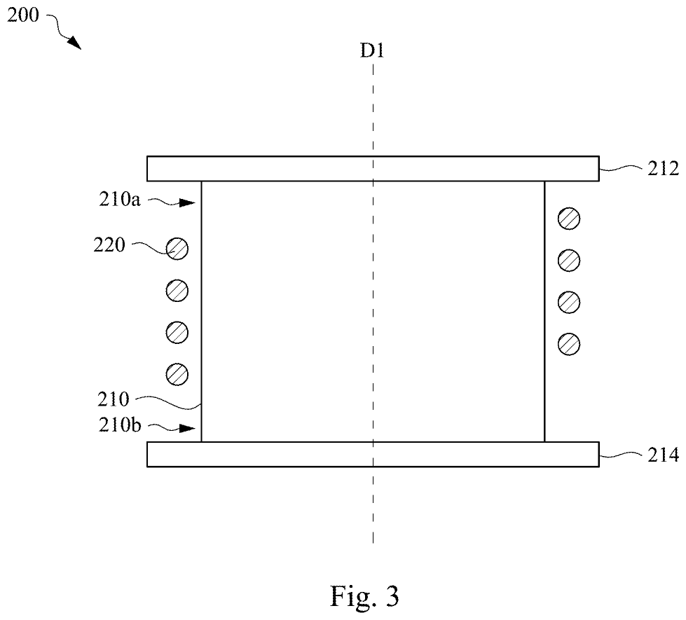

Referring to FIG. 3, FIG. 3 is a side view of the heating device 200 in accordance with some embodiments of the present disclosure. The main body 210 of the heating device 200 is extended along the axial direction D1, and the main body 210 includes a first end part 210a and a second end part 210b, in which the first end part 210a is opposite to the second end part 210b. The member 212 is connected to the first end part 210a of the main body 210, and the member 214 is connected to the second end part 210b of the main body 210. Specifically, the main body 210 is interposed between the member 212 and the member 214. An inner diameter of the member 212 is approximately equal to an outer diameter of the first end part 210a of the main body 210, and an inner diameter of the member 214 is approximately equal to an outer diameter of the second end part 210b of the main body 210. An outside of the main body 210 is surrounded by the induction coil 220.

In the embodiment of FIG. 3, the main body 210 is made of a magnetic induction material. It should be understood that magnetic induction material may be a material that can be induced by the coil and converted into thermal energy. In some examples, the magnetic induction material may include, but is not limited to, iron-based materials, nickel-based materials, cobalt-based materials, titanium-based materials, ferrite-based materials, graphite, or combinations thereof. Specifically, the induction coil 220 is connected to an alternating current power source to generate an alternating magnetic field around the coil. The alternating magnetic field is used to act on the main body 210 to generate an eddy current on the main body 210. The eddy current loss and hysteresis phenomenon caused by the eddy current cause a hysteresis loss. A resistance heat is formed to generate a thermal energy. Therefore, the induction coil 220 may define an electromagnetic induction heating area of the main body 210, and the thermal energy generated by the electromagnetic induction through main body 210 is conducted to the fluid inside, so that the fluid is heated. In the embodiment of FIG. 3, the electromagnetic induction heating area is the main body 210.

It should be understood that the alternating current power source connected to the induction coil 220 is the alternating current power source through an induction heating machine (e.g., low frequency, medium frequency, high frequency, ultra-high frequency induction heating machine, etc., but is not limited to this). For the heating efficiencies of different fluids, the size, spacing and number of turns of the induction coil 220 may be fixed, and the input frequency power to the induction coil 220 may be adjusted to meet the required energy for heating the fluid per unit of time and space.

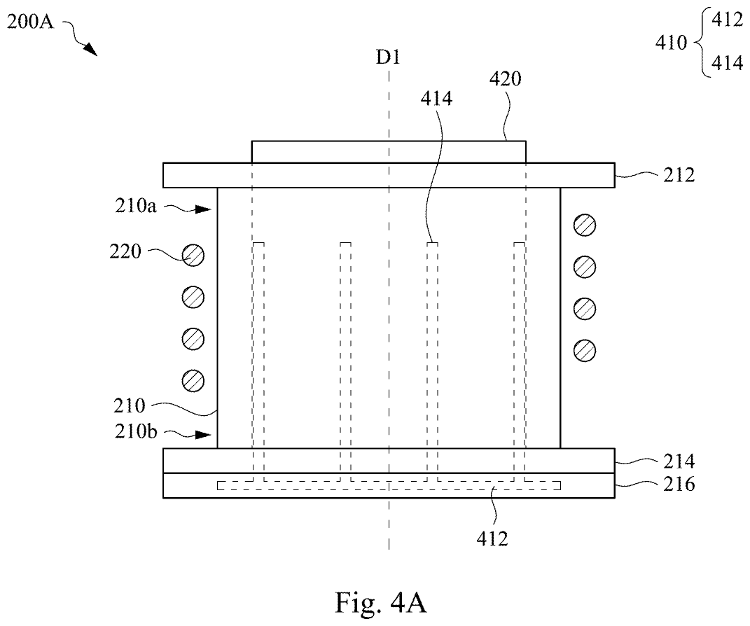

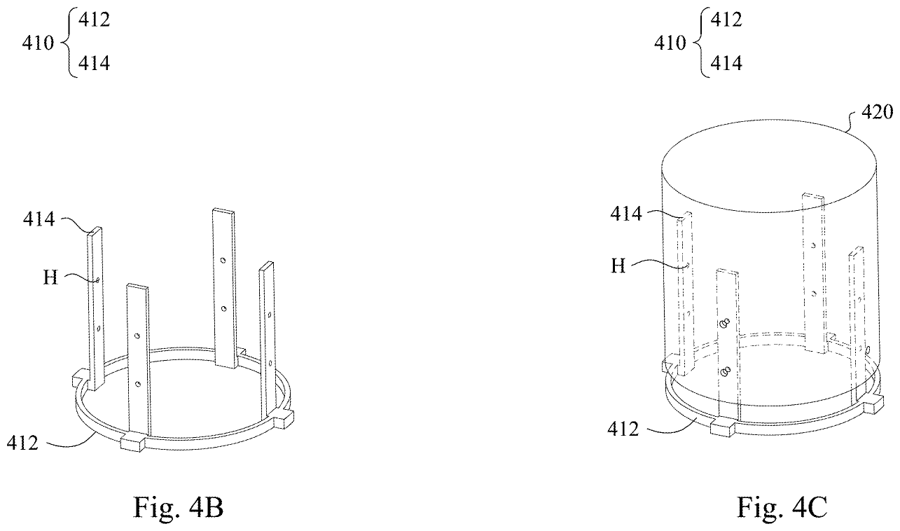

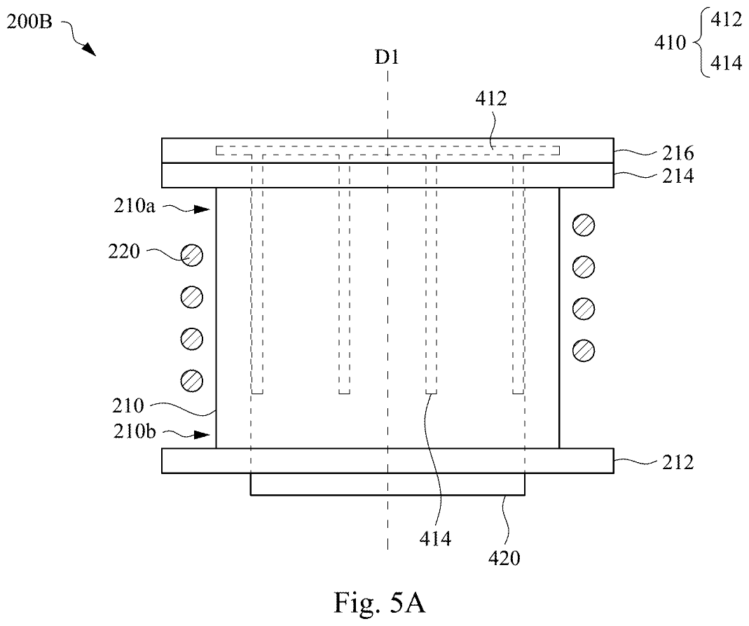

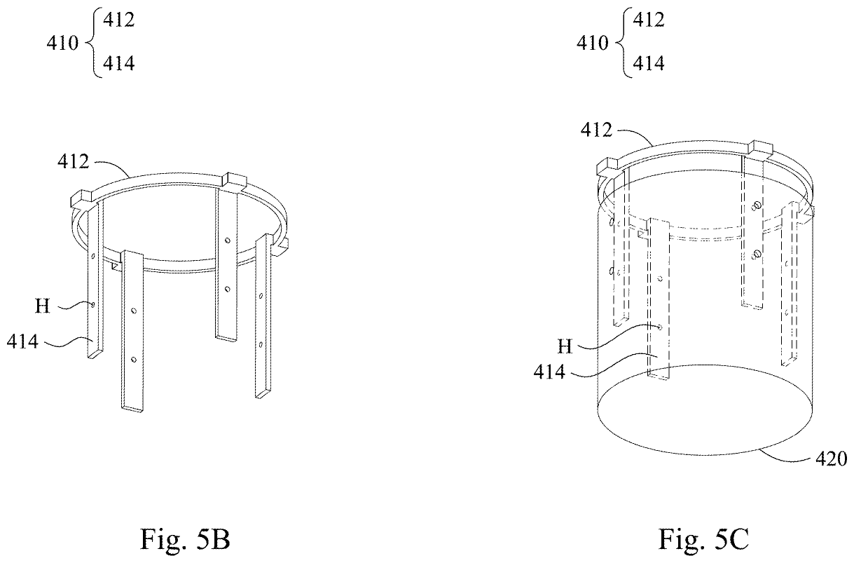

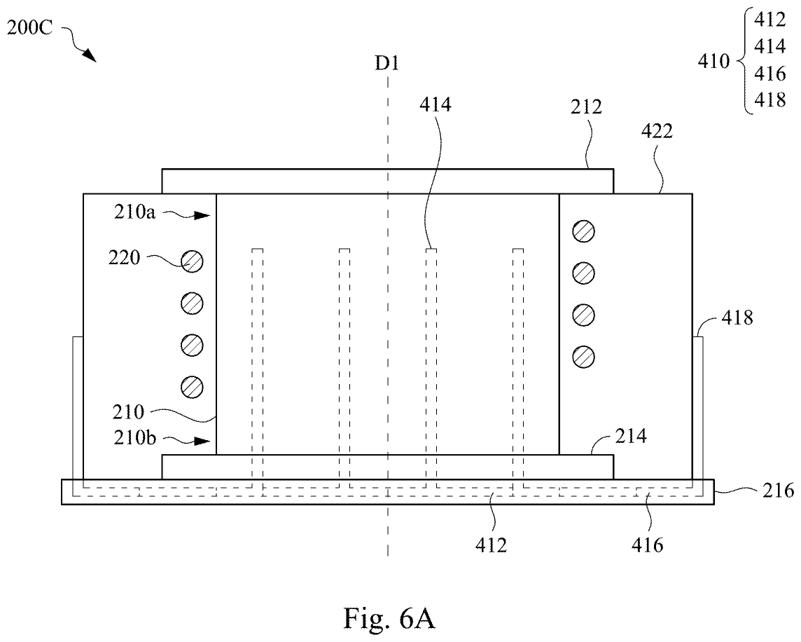

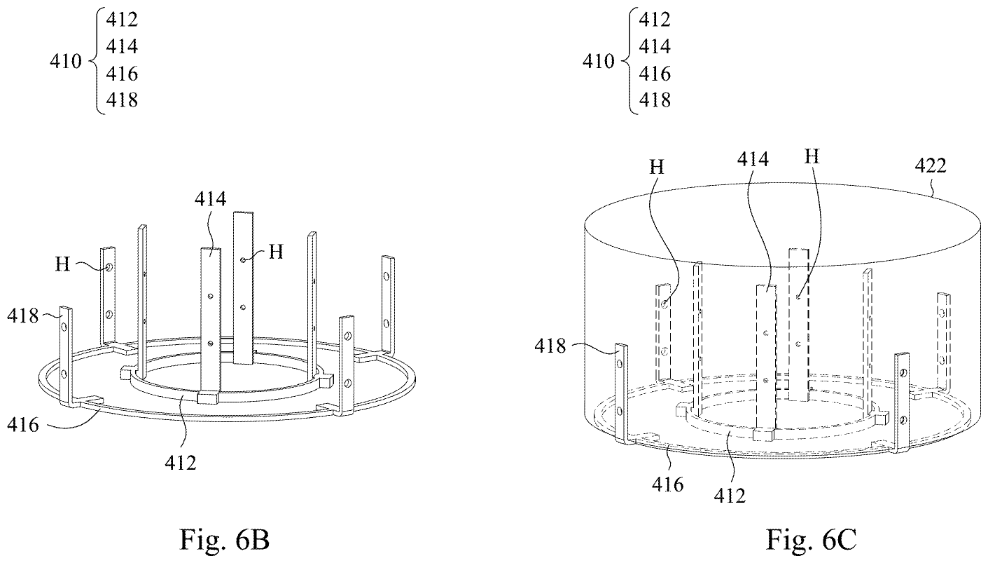

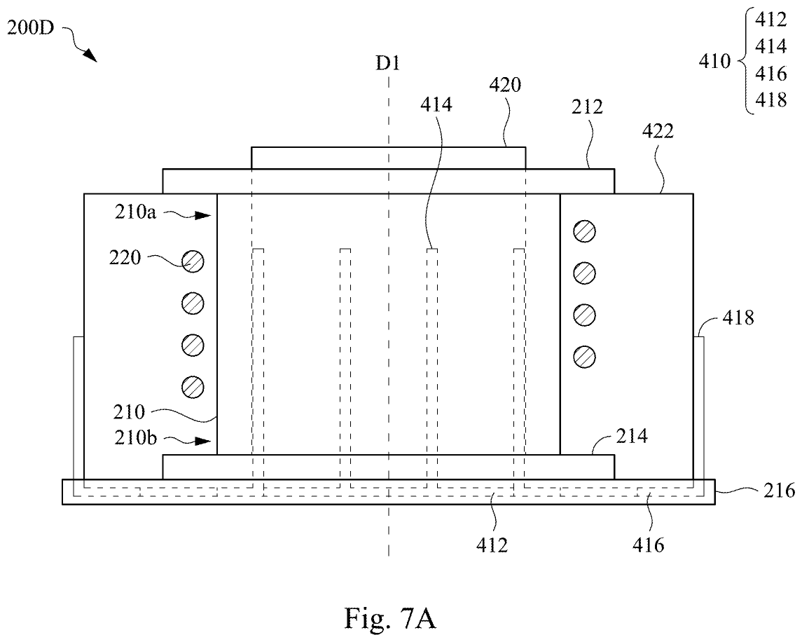

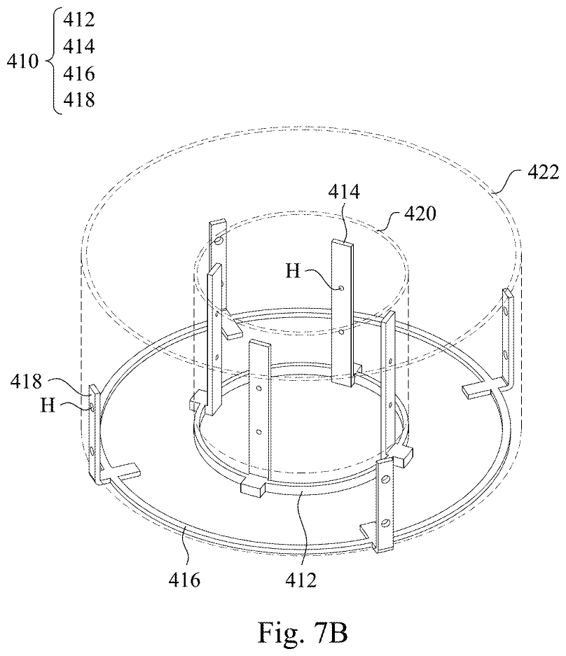

In other embodiments, the disclosed heating device 200 may be a heating device 200A (referring to FIG. 4A), a heating device 200B (referring to FIG. 5A), a heating device 200C (referring to FIG. 6A), or a heating device 200D (referring to FIG. 7A) in different aspects. FIG. 4A, FIG. 5A, FIG. 6A, and FIG. 7A are side views of heating devices 200A, 200B, 200C, and 200D in accordance with some embodiments of the present disclosure. The differences between the heating devices 200A, 200B, 200C, and 200D and the heating device 200 are that the heating devices 200A, 200B, 200C, and 200D include a support member 410 and a magnetic induction element 420 (and/or a magnetic induction element 422).

Referring to FIG. 4A, the heating device 200A further includes a member 216, the support member 410, and the magnetic induction element 420. In some embodiments, the magnetic induction element 420 is presented in a form of solid, hollow, porous, sheet stacked, or powder. The member 216 is connected to the member 214. In some embodiments, the member 216 may be an annular member or a polygonal (such as quadrilateral, hexagonal or octagonal, etc.) member. The support member 410 includes a base 412 and a plurality of extension parts 414 connected to the base 412. In some embodiments, the base 412 may be an annular base or a polygonal (such as quadrilateral, hexagonal or octagonal, etc.) base. The number of the extension parts 414 is not limited to that shown in the figure. The base 412 and the member 216 may be physically connected by tight matching, clamping, locking, riveting, or tenoning, or chemically connected by welding or gluing. The extension parts 414 are extended along the axial direction D1. These extension parts 414 are extended through the inside of the member 214 and extended inside the main body 210. The magnetic induction element 420 is disposed inside the main body 210, and the extension parts 414 are extended inside the magnetic induction element 420. In some examples, the magnetic induction element 420 and the main body 210 are coaxially arranged. In FIG. 4A, although a top surface of the magnetic induction element 420 is shown as protruding beyond a top surface of the member 212, the present disclosure is not limited thereto. In other embodiments, the top surface of the magnetic induction element 420 may also be coplanar with or lower than the top surface of the member 212.

FIG. 4B is a stereogram of the support member 410 of the heating device 200A in FIG. 4A. FIG. 4C is a stereogram of the support member 410 and the magnetic induction element 420 of the heating device 200A in FIG. 4A. As shown in FIG. 4B and FIG. 4C, each of the extension parts 414 of support member 410 may include at least one hole H. In some embodiments, the magnetic induction element 420 is locked on these extension parts 414 through the holes H and fasteners (such as screws), so as to the extension parts 414 is used to stabilize the magnetic induction element 420. In some embodiments, the extension parts 414 and the magnetic induction element 420 may be connected by other fixing methods, such as tight matching, clamping, or other appropriate methods. In other embodiments, the magnetic induction element 420 may be placed directly on the base 412, and these extension parts 414 are located inside the magnetic induction element 420. A projection range of the magnetic induction element 420 overlaps a projection range of the main body 210 along a direction perpendicular to the axial direction D1.

Referring to FIG. 4A again, the magnetic induction element 420 is disposed between the main body 210 and the extension parts 414 of the support member 410, and both the magnetic induction element 420 and the extension parts 414 may be directly contact the fluid inside the main body 210. In one embodiment, the magnetic induction element 420 is made of the magnetic induction material. In some examples, the magnetic induction material may include, but is not limited to, iron-based materials, nickel-based materials, cobalt-based materials, titanium-based materials, ferrite-based materials, graphite, or combinations thereof. When the magnetic induction element 420 is made of the magnetic induction material, the main body 210 may be made of the non-magnetic induction material. In some examples, the non-magnetic induction material may include, but is not limited to, polymer materials, glass materials, ceramic materials, or any combination of the above materials. In some embodiments, the magnetic induction element 420 is a corrosion-resistant material. Specifically, the induction coil 220 is connected to the alternating current power source to generate an alternating magnetic field around the coil. The alternating magnetic field is used to act on the magnetic induction element 420 to generate an eddy current on the magnetic induction element 420. The eddy current loss and hysteresis phenomenon caused by the eddy current cause resistance heat and hysteresis loss to generate thermal energy. Therefore, the induction coil 220 electromagnetically induces the magnetic induction element 420 and defines an electromagnetic induction heating area. The thermal energy generated by the magnetic induction element 420 is conducted to the fluid inside the main body 210, so that the fluid is heated. In the embodiments of FIG. 4A, the electromagnetic induction heating area is the magnetic induction element 420. Similarly, the size, spacing, and number of turns of the induction coil 220 may be fixed, and the input frequency power to the induction coil 220 and the geometric size of the magnetic induction element may be adjusted to meet the required energy for heating the fluid per unit of time and space.

Reference is made to FIG. 5A, FIG. 5B, and FIG. 5C. FIG. 5B is a stereogram of the support member 410 of the heating device 200B in FIG. 5A. FIG. 5C is a stereogram of the support member 410 and the magnetic induction element 420 of the heating device 200B in FIG. 5A. Specifically, the heating device 200B in FIG. 5A is the heating device 200A in FIG. 4A turned upside down (rotated 180 degrees). In the embodiment of FIG. 5A, the magnetic induction element 420 is fixed on the extension parts 414 through the holes H and fasteners (such as screws). The heating method of the heating device 200B in FIG. 5A is the same as that of the heating device 200A in FIG. 5A, and it would not be repeated herein.

Referring to FIG. 6A, the support member 410 of the heating device 200C includes a base 412, a plurality of extension parts 414 connected to the base 412, a base 416, and a plurality of extension parts 418 connected to the base 416. In some embodiments, the base 416 may be an annular base or a polygonal (such as quadrilateral, hexagonal or octagonal, etc.) base. The extension parts 414 and the extension parts 418 are extended along the axial direction D1. The base 412 and the base 416 are connected to the member 216. The base 412 and the base 416 may be physically connected to the member 216 by tight matching, clamping, locking, riveting, or tenoning, or chemically connected by welding or gluing. The extension parts 414 are extended inside of the member 214 and inside the main body 210, and the extension parts 418 are extended inside the main body 210. The heating device 200C includes the magnetic induction element 422. In the embodiment of FIG. 6A, magnetic induction element 422 is in the shape of a hollow cylinder. The magnetic induction element 422 is disposed outside of the main body 210, and the magnetic induction element 422 is connected to the extension parts 418 of the support member 410. In some embodiments, the magnetic induction element 420 is presented in a form of solid, hollow, porous, sheet stacked, or powder. The extension parts 418 of the support member 410 are used to stabilize the magnetic induction element 422 and conduct the thermal energy to the fluid. In some examples, the magnetic induction element 422 and the main body 210 are coaxially arranged. In some embodiments, the magnetic induction element 420 and/or the magnetic induction element 422 further include(s) a cladding layer covering the surface of the magnetic induction element 420 and/or the surface of the magnetic induction element 422. The cladding layer is made of glass or Teflon material to enhance the chemical stability.

FIG. 6B is a stereogram of the support member 410 of the heating device 200C in FIG. 6A. FIG. 6C is a stereogram of the support member 410 and the magnetic induction element 422 of the heating device 200C in FIG. 6A. As shown in FIG. 6B and FIG. 6C, each of the extension parts 418 of the support member 410 may include at least one hole H. In some embodiments, the magnetic induction element 422 is locked on these extension parts 418 through holes H and fasteners (such as screws), thereby using the extension parts 418 to stabilize the magnetic induction element 422. In some embodiments, the extension parts 418 and the magnetic induction element 422 may be connected by other fixing methods, such as tight matching, clamping, or other appropriate methods. In other embodiments, the magnetic induction element 422 may be directly placed on the base 416, and these extension parts 418 is located at the outside of the magnetic induction element 422. A projection range of the magnetic induction element 422 overlaps a projection range of the main body 210 along the direction perpendicular to the axial direction D1.

Referring to FIG. 6A again, the magnetic induction element 422 is disposed between the main body 210 and the extension parts 418 of the support member 410, and a diameter of the magnetic induction element 422 is greater than a winding radius of the induction coil 220. The extension parts 414 of the support member 410 directly contact the fluid inside the main body 210. In some embodiments, the magnetic induction element 422 is made of the magnetic induction material, and the main body 210 is made of the non-magnetic induction material. In some embodiments, magnetic induction element 422 is made of the corrosion-resistant material. Specifically, the induction coil 220 is connected to an alternating current power source to generate an alternating magnetic field around the coil. The alternating magnetic field is used to act on the magnetic induction element 422 to generate an eddy current on the magnetic induction element 422. The eddy current loss and hysteresis phenomenon caused by the eddy current cause resistance heat and hysteresis loss to generate thermal energy. Next, because the magnetic induction element 422 may be thermally connected the extension parts 418 and the base 416, and the base 416 may be thermally connected to the base 412 and the extension parts 414 through the member 216, the thermal energy of the magnetic induction element 422 may be conducted to the fluid inside the main body 210 through the base 412 and the extension parts 414, so that the fluid is heated. In an embodiment in which the main body 210 is made of non-magnetic induction material, the electromagnetic induction heating area is the magnetic induction element 422.

Referring to FIG. 6A again, in an alternative embodiment, both the main body 210 and the magnetic induction element 422 are made of the magnetic induction material. Therefore, when the induction coil 220 is connected to an alternating current power source, both the main body 210 and the magnetic induction element 422 would generate electromagnetic inductions and are heated, so that the fluid inside the main body 210 may be heated by the thermal energy generated by the main body 210 and the thermal energy of the magnetic induction element at the same time. In the embodiment where both the main body 210 and the magnetic induction element 422 are made of the magnetic induction material, the electromagnetic induction heating area is the magnetic induction element 422 and the main body 210. Referring to FIG. 2 and FIG. 6A at the same time, as illustrated in FIG. 6A, since a projection area of the member 216 is larger than that of the member 214 along the axial direction D1, an inner diameter of the member 216 is the same as an inner diameter of the member 214 in order to avoid a fluid leakage in the fluid handling device 120.

Reference is made to FIG. 7A and FIG. 7B. FIG. 7B is a stereogram of the support member 410 and the magnetic induction elements 420 and 422 of the heating device 200D in FIG. 7A. The heating device 200D in FIG. 7A has the same support member 410 as the heating device 200C in FIG. 6A. The heating device 200D has the magnetic induction element 420 and the magnetic induction element 422, in which the magnetic induction element 420 is disposed inside the main body 210, and the magnetic induction element 422 is disposed outside the main body 210. The extension parts 414 of the support member 410 are connected to the magnetic induction element 420, and the extension parts 418 of the support member 410 are connected to the magnetic induction element 422, as shown in FIG. 7B.

Referring to FIG. 7A again, in one embodiment, the magnetic induction elements 420 and 422 are made of the magnetic induction materials, and the main body 210 is made of the non-magnetic induction material. In some embodiments, magnetic induction elements 420 and 422 are made of materials with high chemical stability. Therefore, the thermal energy of the magnetic induction element 420 may be directly contacted the fluid inside the main body 210 and is conducted, and the thermal energy of the magnetic induction element 422 is thermally connected to the fluid inside the main body 210 through the support member 410 (including the extension parts 418, the base 416, the base 412, and the extension parts 414), and the member 216, so that the fluid is heated. In the embodiment in which the main body 210 is made of the non-magnetic induction material, the electromagnetic induction heating areas are magnetic induction elements 420 and 422.

Referring to FIG. 7A again, in an alternatively embodiment, the main body 210 and magnetic induction elements 420 and 422 are made of magnetic induction materials. Therefore, when the induction coil 220 is connected to an alternating current power source, the main body 210 and the magnetic induction elements 420 and 422 would generate electromagnetic inductions and are heated, so that the fluid inside the main body 210 may be thermally connected and heated by the thermal energy generated by the main body 210 and the thermal energy of the magnetic induction elements 420 and 422 at the same time. In the embodiment where the main body 210 and the magnetic induction elements 420 and 422 are made of magnetic induction materials, the electromagnetic induction heating areas are the magnetic induction elements 420 and 422 and the main body 210.

In the embodiment in which the main body 210 is inside the magnetic induction element 420 (such as the heating device 200A in FIG. 4A, the heating device 200B in FIG. 5A, and the heating device 200D in FIG. 7A), energy may be avoided from escaping to the outside of the main body 210.

Referring to FIG. 2 again, the heating device 200 of the fluid handling device 120 may be replaced by the heating devices 200A, 200B, 200C, or 200D disclosed above. In addition, the above-mentioned heating devices 200C and 200D may also be rotated 180 degrees to become inverted heating devices 200C and 200D.

It should be noted that since the member 216 in FIG. 2 is used as the base 412 (and/or the base 416) of the support member 410, the member 216 may be configured as required. Specifically, when the heating device (i.e. the heating device 200 in FIG. 3) does not include the support member 410 and the magnetic induction element 420 (and/or the magnetic induction element 422), there is no need to set the member 216. When the heating device (i.e., the heating devices 200A, 200B, 200C, and 200D in FIGS. 4A, 6A, and 7A) includes the support member 410 and the magnetic induction element 420 (and/or magnetic induction element 422), there is a need to set the member 216.

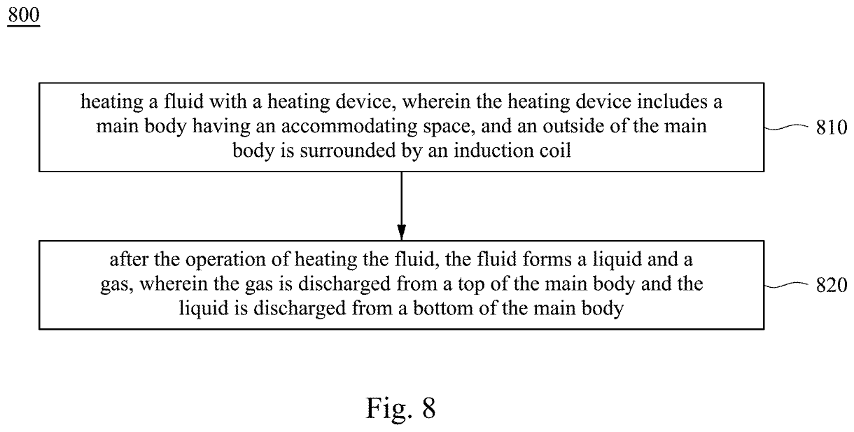

FIG. 8 is a flowchart of a method 800 for heating a fluid in accordance with some embodiments of the present disclosure. The method for heating the fluid 800 includes a step 810 and a step 820. In the step 810, the fluid is heated with the heating device 200 (or the heating devices 200A, 200B, 200C, or 200D). Heating the fluid includes the following operations. The fluid is provided inside the main body 210 from a top of the main body 210. The alternating current power source is used to cause the induction coil 220 to generate a magnetic field, thereby defining an electromagnetic induction heating area. The fluid is heated with the electromagnetic induction heating area. In the step 820, after the operation of heating the fluid, the fluid forms a liquid and a gas, wherein the gas is discharged from the top of the main body 210 and the liquid is discharged from a bottom of the main body 210. In some embodiments, a gas exhaust device may be through natural exhaust, a high-pressure pressure relief device and/or an evacuating equipment. The evacuating equipment may improve the efficiency of concentrating or vaporizing the fluid.

The method disclosed in the above steps 810 and 820 is a method for heating a dynamic fluid. Specifically, a flow control system may be used to control the flow rate of the liquid in the fluid handling device 120 (referring to FIG. 2), so that the liquid can be fully heated when passing through the heating device 200. The fluid is then discharged below the main body 210 to achieve continuously heating of the fluid.

The disclosure also provides a method for heating an static fluid. Specifically, before providing the fluid to the inside of the main body 210 from the top of the main body 210, a valve (not shown) located below the heating device 200 is closed, so that the fluid to be heated remains in the body 210. The valve may be, for example, a ball valve, a butterfly valve or a pipe plug. Next, the static fluid is heated. In some embodiments, before heating the static fluid, the pressure in the main body 210 are reduced to about 0.3 atm to about 0.4 atm, and the low pressure is maintained while heating the fluid. In some embodiments, during the heating device heats the fluid, a liquid level of the fluid is detected with a liquid level gauge inside the main body 210 (for example, in the detector 124), and the liquid level is used to determine whether the heating for the fluid is completed. After heating the fluid, the valve located under the heating device is opened. In some embodiments, the valve may be disposed in the drain device 126 and/or the drain device 128.

In some embodiments, the support members 410 and the magnetic induction elements 420 and 422 in the heating devices 200A, 200B, 200C, and 200D may be damaged due to contact with chemical fluids. Therefore, the support member 410 and/or magnetic induction elements 420 and 422 in the heating devices 200A, 200B, 200C, and 200D may need to be replaced when necessary. In an alternative embodiments, referring to FIG. 2, parts of the heating device 200 (or the heating devices 200A, 200B, 200C, or 200D) may be directly removed and replaced with a new heating device 200 (or the heating devices 200A, 200B, 200C, or 200D). In addition, the sizes and shapes of the magnetic induction elements 420 and 422, the size, spacing and number of turns of the induction coil 220, and the input frequency power and geometric structure size of the induction coil 220 may be adjusted according to the properties of the heated fluid to achieve the required time and temperature for heating the fluid.

The present disclosure provides the heating device that uses the electromagnetic induction coil to heat the liquid in the main body. The heating device disclosed in the present disclosure can reduce problems such as thermal energy dissipation or bumping, and improve the heating efficiency of heating the fluid, thereby effectively controlling the heating system. The magnetic induction element in the heating device disclosed in the present disclosure is made of material with chemical stability, so it can be applied to chemical fluids, thereby increasing the service life of the heating device.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A heating device, comprising:
a main body having an accommodating space, wherein the main body is configured to accommodate a fluid, and the main body comprises a first end part and a second end part opposite to the first end part;
a first member connected to the first end part of the main body;
a second member connected to the second end part of the main body;
a third member connected to the second member;
an induction coil surrounded an outside of the main body;
a support member comprising a first base and a plurality of first extension parts connected to the first base, wherein the first base is connected to the third member, and the first extension parts are respectively extended to the accommodating space; and
a first magnetic induction element disposed in the accommodating space.

2. The heating device of claim 1, wherein the heating device further comprises a second magnetic induction element, the support member further comprises a second base and a plurality of second extension parts connected to the second base, wherein the main body is disposed inside the second magnetic induction element, the second base is connected to the third member, and the second extension parts are respectively connected to the second magnetic induction element.

3. The heating device of claim 1, wherein the first magnetic induction element is made of a magnetic induction material including iron-based materials, nickel-based materials, cobalt-based materials, titanium-based materials, ferrite-based materials, or graphite.

4. The heating device of claim 1, wherein the first magnetic induction element further comprises a cladding layer, the cladding layer covers a surface of the first magnetic induction element, and the cladding layer is made of glass or Teflon material.

5. The heating device of claim 1, wherein the first magnetic induction element is presented in a form of solid, hollow, porous, sheet stacked, or powder.

6. The heating device of claim 1, wherein the main body is made of a non-magnetic induction material including polymer, glass, or ceramic, or a magnetic induction material including iron-based materials, nickel-based materials, cobalt-based materials, titanium-based materials, ferrite-based materials, or graphite.

7. A heating device, comprising:
a main body having an accommodating space, wherein the main body is configured to accommodate a fluid, and the main body comprises a first end part and a second end part opposite to the first end part;
a first member connected to the first end part of the main body;
a second member connected to the second end part of the main body;
a third member connected to the second member;
an induction coil surrounded an outside of the main body;
a support member comprising a first base, a plurality of first extension parts connected to the first base, a second base, and a plurality of second extension parts connected to the second base, wherein the first base and the second base are connected to the third member, and the first extension parts are respectively extended to the accommodating space; and
a magnetic induction element disposed on the outside of the main body, wherein the second extension parts are respectively connected to the magnetic induction element.

8. The heating device of claim 7, wherein the magnetic induction element is made of a magnetic induction material including iron-based materials, nickel-based materials, cobalt-based materials, titanium-based materials, ferrite-based materials, or graphite.

9. The heating device of claim 7, wherein the main body is made of a non-magnetic induction material including polymer, glass, or ceramic, or a magnetic induction material including iron-based materials, nickel-based materials, cobalt-based materials, titanium-based materials, ferrite-based materials, or graphite.

10. The heating device of claim 7, wherein the magnetic induction element and the support member are physically connected by tight matching, clamping, locking, riveting, or tenoning, or chemically connected by welding or gluing.

11. A method for heating a fluid, comprising:
heating the fluid with a heating device, wherein the heating device comprising a main body having an accommodating space, and an outside of the main body is surrounded by an induction coil, wherein the heating device comprises:
a first member connected to a first end part of the main body;
a second member connected to a second end part of the main body, wherein the second end part is opposite to the first end part;
a third member connected to the second member;
a support member comprising a first base and a plurality of first extension parts connected to the first base, wherein the first base is connected to the third member, and the first extension parts are extended to the accommodating space; and
a first magnetic induction element disposed in the accommodating space,
wherein the operation of heating the fluid comprises:
providing the fluid into the accommodating space from a top of the main body;
generating a magnetic field by the induction coil using an alternating current power source, thereby defining an electromagnetic induction heating area; and
heating the fluid with the electromagnetic induction heating area, wherein the first magnetic induction element is electromagnetically heated by the magnetic field; and
after the operation of heating the fluid, the fluid forms a liquid and a gas, wherein the gas is discharged from the top of the main body, and the liquid is discharged from a bottom of the main body.

12. The method of claim 11, further comprising closing a valve located below the heating device before providing the fluid into the accommodating space from the top of the main body.

13. The method of claim 11, further comprising detecting a liquid level of the fluid with a liquid level gauge inside the main body and determining whether the heating of the fluid is completed with the liquid level during heating the fluid.

14. The method of claim 11, further comprising opening a valve located below the heating device after heating the fluid.

15. The method of claim 11, wherein the support member further comprises a second base and a plurality of second extension parts connected to the second base, and the second base connected to the third member,
wherein the heating device further comprises a second magnetic induction element, the second magnetic induction element is disposed on an outside of the accommodating space, and the second extension parts are respectively extended to and connected to the second magnetic induction element,
wherein during the operation of heating the fluid with the electromagnetic induction heating area, the second magnetic induction element is electromagnetically heated by the magnetic field.
